(19) United States
(12) Patent Application Publication
(10) Pub. No.: US 2019/0038057 A1
(43) Pub. Date: Feb. 7, 2019

(54) Connected Spoon Cooperating with Figurine on phone

(71) Applicant: SLOW CONTROL, Saint Paul-La Réunion (FR)

(72) Inventor: Jacques LEPINE, Paris (FR)

(21) Appl. No.: 15/998,309

(22) PCT Filed: Sep. 28, 2016
(86) PCT No.: PCT/FR2016/000153

§ 371 Date: Aug. 6, 2018

(30) Foreign Application Priority Data
Oct. 2, 2015 (FR) 15 02053

(51) Int. Cl. A47G 21/02; A47G 21/04

(52) U.S. Cl. CPC A47G 21/02; A47G 21/04; H04W 4/80; A47G 2200/08; A47G 2200/143

(57) ABSTRACT

A set of animated meals for a toddler comprising the cooperation of a connected spoon (C) and a figurine (F) housing a mobile phone characterized in that the spoon consists of a handle (M) and a removable head (T) adaptable to the handle (M), the handle (M) houses an electronic card (16) powered by a battery, a processing chip, a wireless link transmitter which communicates with a remote application on a mobile phone, two action buttons (17A, 17B) that trigger action commands, A and B, by the wireless link to the mobile application of a mobile phone, an ignition button (15) which puts the electronic card in tension or off, the physical figurine (F) represents a character (P) held by two complementary snap closure straps (Sa, Sb) which surround the mobile phone and cover the surface of the mobile phone screen, the figurine (F) is made in a translucent elastic material, it includes reliefs, transparencies, holes (30), the action orders A and B trigger visual animations (40) on the screen and/or sound by the telephone speaker mobile.

The present invention relates to a multimedia animation device for improving the meal of a child. The invention is particularly intended for very young children in the range 1 to 3 years and offers by maintaining mechanisms of attention a pedagogy of taking meals that meets the needs of parents and children.

It is well known that it can be difficult to feed young children at the age hey use spoon. Children have a limited capacity for concentration that does not allow them to stay attentive for a long time and concentrate on taking meals. Children can also refuse to eat such or such type of food which is beneficial to them. We think for example of vegetable purees. This is a source of worry and fatigue for both children and parents.

There are electronic cutlery that triggers on-the-table animations while eating. These cutlery contains an integrated animation, sound or light that is located in the spoon itself. This animation can be triggered by a precise location of the spoon, for example over a plate, or by placing the spoon in the mouth. There are no electronic cutlery that interacts with a mobile phone application on a phone during the meal. There is also no figurine that hides the child's mobile phone during the meal.

Indeed, a problem is to create an enriched interaction that is acceptable to parents and children. Parents refuse or hinder their young children from watching digital screens.

An object of the invention is to provide an animation device that keeps the child in a state of attention conducive to the taking of meals.

An object of the invention is to provide a device that is economical and easily industrializable.
An object of the invention is to interact and adapt to any form, and any size of equipment in a mobile phone or tablet of different brands.
An object of the invention is to provide a device that allows to easily vary the possible animations on the screen of the mobile phone.
An object of the invention is to take advantage of the power of a mobile terminal to provide an animation to a young child, but to find a ploy to hide the screen of the mobile phone to not trigger a child addiction.
An object of the invention is to propose an interaction which is partly in direct contact with the directly visible screen, partly in transparency with light diffused through a translucent zone, and/or partly masked with a part of the light. screen that is not visible, neither directly nor through transparency. Of course animations generated on the mobile application can be visual. They also have sounds. These sounds can recall characteristic events, appetizers, character traits of the character.

An object of the invention is to provide a solution that is educational, playful easy to use and that makes life easier for parents and children.

The attached figures represent a particular embodiment of the invention in which:

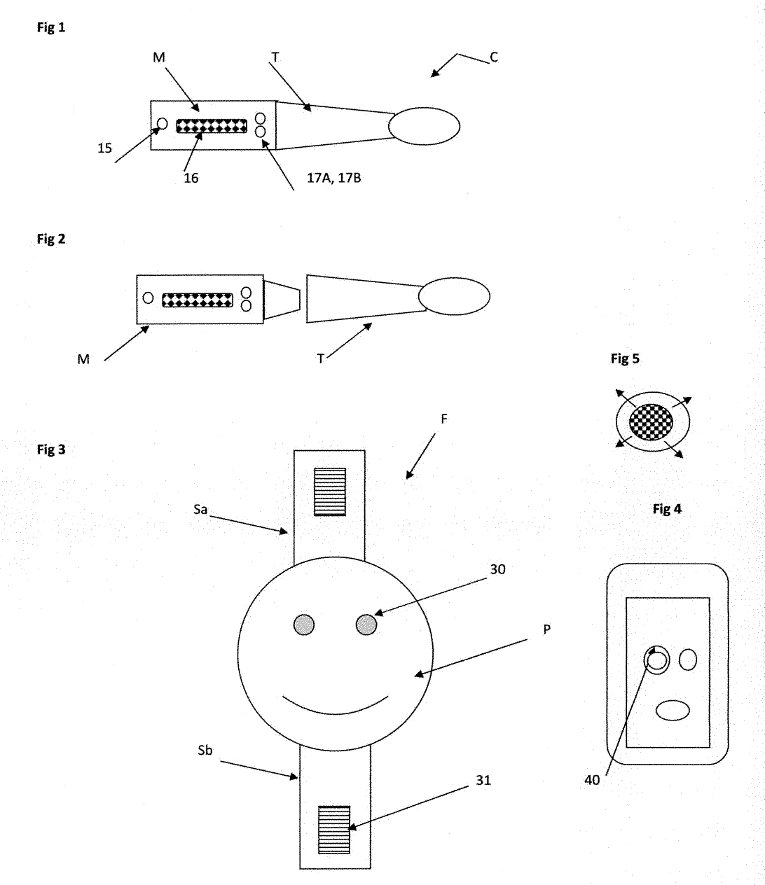

FIG. 1 shows a spoon according to the invention

FIG. 2 represents the method of mounting a spoon according to the invention

FIG. 3 represents a character figurine according to the invention

FIG. 4 represents an interactive application with the figurine and with the mobile phone according to the invention

FIG. 5 represents an interface for aligning the holes with the animations

FIG. 1 shows a spoon (C) according to the invention. This spoon consists of two removable and mechanically assembled parts, handle part (M) and head part (T), see FIG. 2. The head part (T) can offer different head sizes and different head materials, more or less plastic tender or bowl of spoon more or less accentuated. The handle portion houses an electronic card (16) powered by a battery. The electronic card (16) includes a processing chip, a wireless link transmitter that communicates with a remote application on a mobile phone. The card also includes two action buttons (17A, 17B) that trigger action commands, A and B, by the wireless link to the mobile application. These action orders are for example an animation A which corresponds to the phase before the mouthing of the spoon, and an animation B which corresponds to the mouthing phase of the spoon. Typically noise sounds A of an aircraft A and eating noise B can be triggered in real time on the mobile application by pressing the button (17A) or the button (17B). These action buttons are placed in the middle of the width of the handle of the spoon, on the top, near the connection with the removable head of the spoon. The handle also includes an ignition button (15) which turns the electronic card on or off.

The parent proceeds according to the following steps
step 1: switching on the range by means of the tensioning button (15)
step 2: pairing the spoon with the mobile application
step 3: dressing the figurine on the mobile phone
step 4: launch animations during the meal, either by action of the parent on the action buttons (17A, 17B), or by the automatic and/or random operation of the application

FIG. 3 shows a figurine (F) character according to the invention which comprises two straps (Sa, Sb) which encircle the mobile phone from top to bottom. These straps include fastening zones (31) which operate by clipping, of the mushroom series type which are fixed in a series of slots. This belt solution can accommodate a wide variety of mobile phone height. The figure has between its two straps a character (P) which is intended to cover the surface of the screen of mobile phones. The figurine is preferably made of a translucent elastic material, such as silicone. The character (P) includes reliefs, transparencies, holes (30) that reveal the screen. Typically these holes (30) in the character are positioned on the eyes or on the mouth, the mobile application displays under these holes an animation of eyes that display emotions and mouth that speaks or that eats. For transparency the character comes alive with color, for example red on the cheeks, gurgling animations on the stomach, and other types of entertainment. The width of the figurine exceeds the maximum width of the mobile phone range of the market. The figurine being stretched from top to bottom, the figurine holds on its width by the rigidity generated by the vertical tension. The figurine can for example propose a character with lateral or vertical growths, of the type ear, arm, hair, feet.

FIG. 4 represents an interactive application that presents isolated specific animation areas (40) that the user has positioned with his finger in front of the holes of the figurine.

FIG. 5 shows an interface for plating and aligning holes with animations. The animation is surrounded by a radially halftone halo around its circumference, which means that the user can immediately see how to move the animations in front of the holes, as these holes will overlap the area and the radial arrows will indicate in which direction to move them. The big advantage of this solution is that the user can align the holes once the figurine is mounted on the mobile phone.

We understand how this figurine solution makes it easy to adapt to all mobile phone sizes, and how this animation solution makes it easy to align the figurine with the mobile phone regardless of its size. This solution is therefore a universal interactive solution for animating a figurine with a mobile phone. It adapts to an object connected like a spoon. It can also adapt to a toy like a magic wand, or to another connected object that does not necessarily concern a child.

The present invention thus relates to a set of animation of meals for young child comprising a spoon (C) consisting of a handle (M) and a head (T) removable adaptable on the handle (M), the handle (M) houses an electronic card (16) powered by a battery, a processing chip, a wireless link transmitter which communicates with a remote application on a mobile phone, two action buttons (17A, 17B) which trigger commands from actions, A and B, by the wireless link to the mobile application of a mobile phone, an ignition button (15) which turns on or off the electronic card, a physical figurine (F) representing a character (P) maintained by two straps (Sa, Sb) complementary clipping closure that surround the mobile phone and cover the surface of the screen, the figure (F) is made of a translucent elastic material, it includes reliefs, transparencies, the holes (30) which allow filtering animations (40) from the screen that pass through the figurine, the action orders A and B trigger visual animations (40) on the screen and/or sound by the loudspeaker mobile phone.

The present invention therefore relates to a set of animation for a meal for young children, characterized in that the action buttons (17A, 17B) are placed in the middle of the width of the handle (M) of the spoon, on the top, near the connection with the removable head (T) of the spoon.

The present invention therefore relates to a set of animation for young children comprising, characterized in that the straps (Sa, Sb) comprise gripping zones (31) which operate by clipping, of the type series of mushroom shape which are fixed in a series of slots.

The present invention thus relates to a set of animated meal for young child with a character (P) which includes holes (30) in the position on the eyes or mouth, the mobile application displays respectively under these holes an animation eyes that display emotions and mouth that speaks or that eats.
The present invention thus relates to a set of animated meals for young children including a visual animation portion of the animation of the application that responds to a tactile instruction to be placed by the user vis-à-vis the holes of the character in front of the phone screen.
It is clear that many variants that may be combined can be made here without ever departing from the scope of the invention as defined below.

1- A set of animated meals for a toddler comprising the cooperation of a connected spoon (C) and a figurine (F) housing a mobile phone characterized in that the spoon consists of a handle (M) and a removable head (T) adaptable to the handle (M), the handle (M) houses an electronic card (16) powered by a battery, a processing chip, a wireless link transmitter which communicates with a remote application on a mobile phone, two action buttons (17A, 17B) that trigger action commands, A and B, by the wireless link to the mobile application of a mobile phone, an ignition button (15) which puts the electronic card in tension or off, the physical figurine (F) represents a character (P) held by two complementary snap closure straps (Sa, Sb) which surround the mobile phone and cover the surface of the mobile phone screen, the figurine (F) is made in a translucent elastic material, it includes reliefs, transparencies, holes (30), the action orders A and B trigger visual animations (40) on the screen and/or sound by the telephone speaker mobile.

2- Animation set of meals for young child according to claim 1 characterized in that the action buttons (17A, 17B) are placed in the middle of the width of the handle (M) of the spoon, on top, close of the connection with the removable head (T) of the spoon.

3- Animation set for young child feeding according to claim 1 characterized in that the straps (Sa, Sb) comprise hooking zones (31) which operate by clipping, type series of mushroom shape which are wedged in a slot series.

4- Animation set for young child feeding according to claim 1 characterized in that the character (P) comprises holes (30) in the drawing of the character positioned on the eyes and/or on the mouth, the mobile application displays respectively under these holes an animation of eyes that display emotions and mouth that speaks or that eats.

5- Animation set for young child feeding according to claims 1 and 4 characterized in that the animation portion of the application animation animation responds to a tactile instruction to be placed by the user vis-à-vis screw holes of the character placed in front of the screen of the phone.

6- Animation set for young child feeding according to claims 1, 4 and 5 characterized in that the visual animation elements is surrounded by a halo arrowed radially on its circumference which makes the user see immediately at sight through the holes how to move the animations in front of the holes of the figurine.
